(19) United States
(12) Patent Application Publication
(10) Pub. No.: US 2018/0322108 A1
(43) Pub. Date: Nov. 8, 2018

(54) ITEM NAME ASSOCIATION PROCESSING METHOD, COMPUTER-READABLE RECORDING MEDIUM, AND INFORMATION PROCESSING APPARATUS

(71) Applicant: FUJITSU LIMITED, Kawasaki-shi (JP)

(72) Inventors: Tsuyoshi Maita, Aomori (JP); Nobumi Noro, Aomori (JP); Tetsu Tanaka, Hirosaki (JP)

(73) Assignee: FUJITSU LIMITED, Kawasaki-shi (JP)

(21) Appl. No.: 16/036,088

(22) Filed: Jul. 16, 2018

Related U.S. Application Data
(63) Continuation of application No. PCT/JP2016/053389, filed on Feb. 4, 2016.

(51) Int. Cl. G06F 17/24; G06F 17/21; G06F 17/30

(52) U.S. Cl. CPC G06F 17/246; G06F 17/245; G06F 17/30598; G06F 17/30569; G06F 17/211

(57) ABSTRACT

An item name association processing method includes: extracting a plurality of item names from table format data, using a processor; referring to a storage in which a plurality of item groups is stored and determining which item group includes an item name that has a predetermined similar relationship with the plurality of individual extracted item names, using the processor; and selecting, as an association target, from among the plurality of item names, regarding the item name from which a positive determination result has been obtained, the item name having the predetermined similar relationship and submitting, as an association candidate, from among the plurality of item names, regarding the item name from which a negative determination result has been obtained, the item group determined to include the item name having the predetermined similar relationship with another item name, using the processor.

### CROSS-REFERENCE TO RELATED APPLICATION

This application is a continuation of International Application No. PCT/JP2016/053389, filed on Feb. 4, 2016, the entire contents of which are incorporated herein by reference.

### FIELD

The embodiment discussed herein is related to an item name association processing method, a computer-readable recording medium, and an information processing apparatus.

### BACKGROUND

In recent years, for example, local municipalities aggregate various kinds of information about tourist spots in their regions in the local municipalities and post the information on their home pages on the Internet. By receiving information provided from facilities in tourist spots, the local municipalities collect information on the tourist spots. Furthermore, in some cases, companies consigned by the municipalities receive information on tourist spots as open data from the municipalities and input the information. In this case, the provided information is information based on various formats of, for example, table format data, such as various kinds of spreadsheet software with a file format, such as a comma-separated values (CSV) file format, a Tab-Separated Values (TSV) file format, and the like.

Patent Document 1: Japanese Laid-open Patent Publication No. 2013-015909

However, in the collected information, item names are not sometimes unified, such as full names and names. Consequently, it is conceivable that the item names are unified by associating the item names of the collected information with defined standardized vocabularies. However, in order to search a standardized vocabulary appropriate for an item name, time and effort are needed for a search by persons having proper knowledge.

### SUMMARY

According to an aspect of an embodiment, an item name association processing method includes: extracting a plurality of item names from table format data, using a processor; referring to a storage in which a plurality of item groups is stored and determining which item group includes an item name that has a predetermined similar relationship with the plurality of individual extracted item names, using the processor; and selecting, as an association target, from among the plurality of item names, regarding the item name from which a positive determination result has been obtained, the item name having the predetermined similar relationship and submitting, as an association candidate, from among the plurality of item names, regarding the item name from which a negative determination result has been obtained, the item group determined to include the item name having the predetermined similar relationship with another item name, using the processor.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of the configuration of an information processing apparatus according to an embodiment;

FIG. 2 is a diagram illustrating an example of table format data and table data;

FIG. 3 is a diagram illustrating an example of an information DB;

FIG. 4A is a diagram illustrating an example of a vocabulary DB;

FIG. 4B is a diagram illustrating an example of the vocabulary DB;

FIG. 4C is a diagram illustrating an example of the vocabulary DB;

FIG. 5 is a diagram illustrating an example of a history DB;

FIG. 6 is a diagram illustrating an example of extracting table data;

FIG. 7 is a diagram illustrating another example of extracting table data;

FIG. 8 is a diagram illustrating an example of an editing process;

FIG. 9 is a diagram illustrating another example of the editing process;

FIG. 10 is a diagram illustrating another example of the editing process;

FIG. 11 is a diagram illustrating an example of de-concatenation of cells that are present in rows other than an item row;

FIG. 12 is a diagram illustrating an example of creating item names;

FIG. 13 is a diagram illustrating another example of creating item names;

FIG. 14 is a diagram illustrating an example of specifying an item row;

FIG. 15 is a diagram illustrating another example of specifying an item row;

FIG. 16 is a diagram illustrating another example of specifying an item row;

FIG. 17 is a diagram illustrating another example of specifying an item row;

FIG. 18 is a diagram illustrating an example of specifying an item column;

FIG. 19 is a diagram illustrating another example of specifying item columns;

FIG. 20 is a diagram illustrating an example of adding an item row;

FIG. 21 is a diagram illustrating another example of adding an item row;

FIG. 22 is a diagram illustrating an example of table data after shaping;

FIG. 23 is a diagram illustrating an example of an allocation screen;

FIG. 24 is a flowchart illustrating an example of an analysis process according to the embodiment;

FIG. 25 is a flowchart illustrating an example of a standardization process according to the embodiment; and

FIG. 26 is a diagram illustrating an example of a computer that executes item name association processing program.

### DESCRIPTION OF EMBODIMENT

Preferred embodiments of the present invention will be explained with reference to accompanying drawings. The disclosed technology is not limited to the present invention. Furthermore, the embodiments described below can be used in any appropriate combination as long as the embodiments do not conflict with each other.

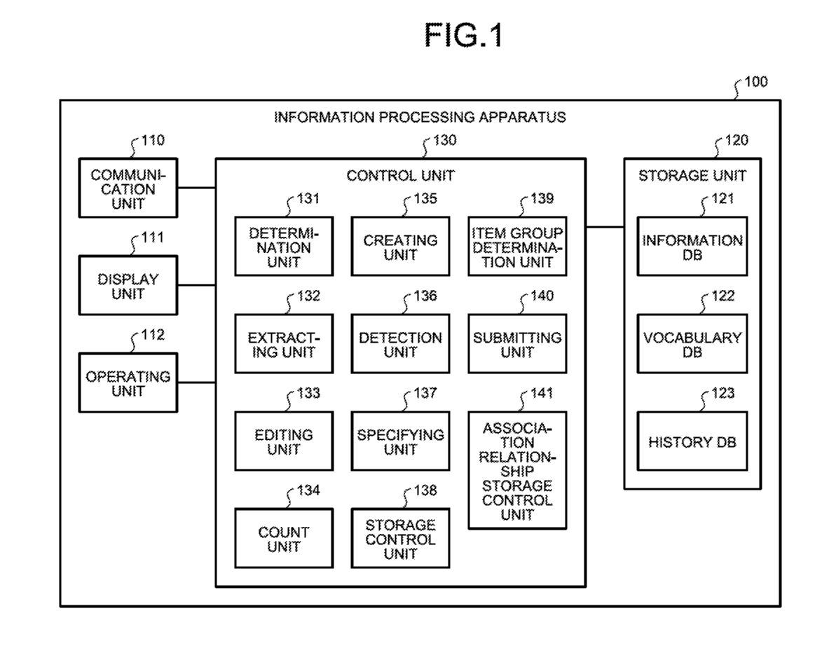

FIG. 1 is a block diagram illustrating an example of the configuration of an information processing apparatus according to an embodiment. An information processing apparatus 100 illustrated in FIG. 1 extracts a plurality of item names from table format data. Furthermore, the information processing apparatus 100 refers to a storage unit in which a plurality of item groups are stored and determines which item group includes an item name that has a predetermined similar relationship with each of the plurality of the extracted item names. Furthermore, regarding the item name from which a positive determination result has been obtained from among the plurality of item names, the information processing apparatus 100 selects the item name having the predetermined similar relationship as an association target. Furthermore, regarding the item name from which a negative determination result has been obtained, the information processing apparatus 100 submits, as an association candidate, the item group that is determined to include the item name having the predetermined similar relationship with another item name. Consequently, the information processing apparatus 100 can associate the item name with a standardized vocabulary. Furthermore, in a description below, a description will be given by mainly focusing on a row direction; however, it is also possible to similarly use for a column direction.

The information processing apparatus 100 illustrated in FIG. 1 includes a communication unit 110, a display unit 111, an operating unit 112, a storage unit 120, and a control unit 130. Furthermore, the information processing apparatus 100 may also include, in addition to the functioning units illustrated in FIG. 1, various functioning units included in a known computer, for example, functioning units, such as various communication devices, input devices, and audio output devices. As an example of the information processing apparatus 100, a stationary type computer, such as a server, may be used. For the information processing apparatus 100, in addition to the stationary type computer, such as a server described above, a portable or stationary type personal computer may also be used as the information processing apparatus 100.

The communication unit 110 is implemented by, for example, a network interface card (NIC), or the like. The communication unit 110 is a communication interface that is connected to a terminal device of a user (not illustrated) in a wired or wireless manner via a network (not illustrated) and that manages communication of information with the terminal device. The communication unit 110 receives table format data and selection information from the terminal device. The communication unit 110 outputs the received table format data and the selection information to the control unit 130. Furthermore, the communication unit 110 receives an input of an allocation screen from the control unit 130. The communication unit 110 sends the input allocation screen to the terminal device.

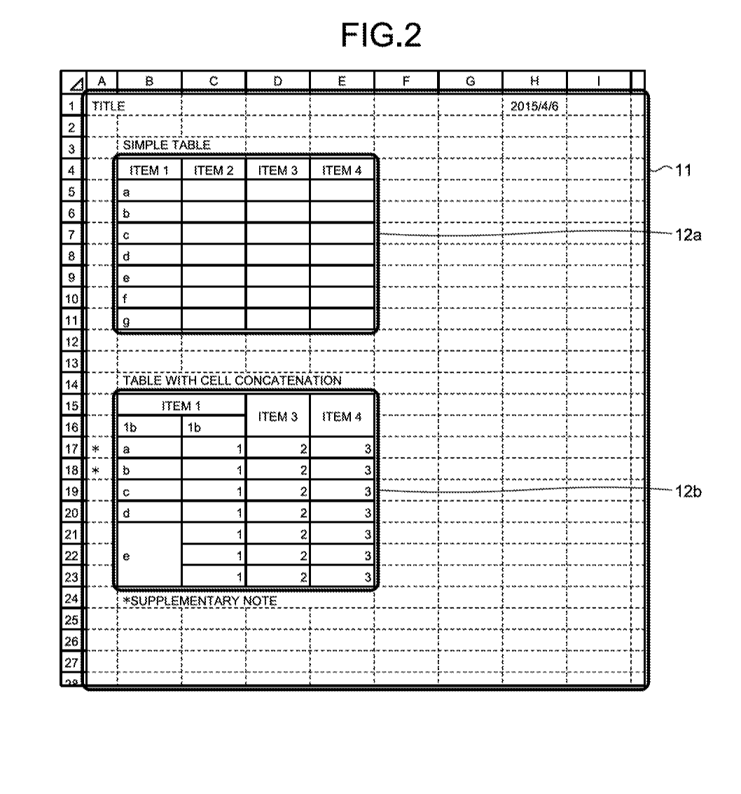

In the following, table format data will be described with reference to FIG. 2. FIG. 2 is a diagram illustrating an example of table format data and table data. Table format data 11 illustrated in FIG. 2 is, for example, data including a plurality of pieces of table data 12a and 12b and the title and the like of table format data 11. Furthermore, in a description below, for example, the whole data in a single file is referred to as table format data and each of the tables in the table format data is referred to as table data. The table format data 11 includes, for example, table data in which an item (header) is present on the top row, table data in which items are present on the top row and on the column of the leftmost column, table data in which cells are concatenated in order to represent a sub item and an item row is present by using two rows. Furthermore, the table data is not limited to this and any data may also be used as long as data can be represented in the form of matrix. Furthermore, regarding the table format data, for example, open data provided from public agencies or municipalities may be used.

A description will be given here by referring back to FIG. 1. The display unit 111 is a display device for displaying various kinds of information. The display unit 111 is implemented by, for example, a liquid crystal display or the like as the display device. The display unit 111 displays various screens, such as a display screen, that is input from the control unit 130.

The operating unit 112 is an input device that receives various operations from an administrator of the information processing apparatus 100. The operating unit 112 is implemented by, for example, a keyboard, mouse, or the like as an input device. The operating unit 112 outputs the operation input by the administrator as operation information to the control unit 130. Furthermore, the operating unit 112 may also be implemented by a touch panel or the like as an input device or, alternatively, the display unit 111 functioning as the display device and the operating unit 112 functioning as the input device may also be integrated as a single unit.

The storage unit 120 is implemented by, for example, a semiconductor memory device, such as a random access memory (RAM) or a flash memory, or a storage device, such as a hard disk or an optical disk. The storage unit 120 includes an information database 121, a vocabulary database 122, and a history database 123. Furthermore, in a description below, a database is abbreviated to DB. Furthermore, the storage unit 120 stores therein information that is used for the processes performed in the control unit 130.

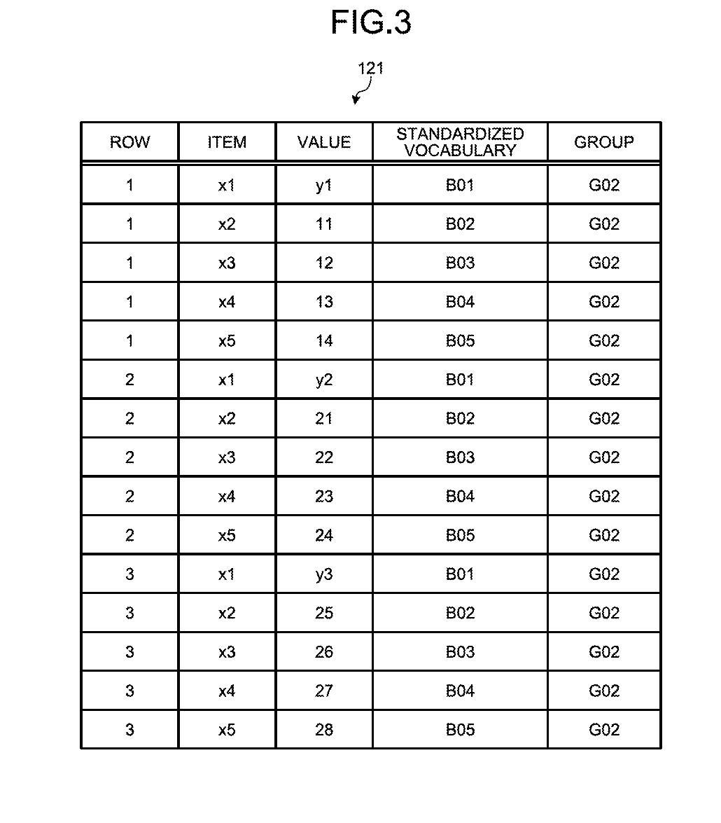

The information DB 121 stores therein, regarding the table data, items, values, and vocabularies in association with each other. FIG. 3 is a diagram illustrating an example of the information DB. As illustrated in FIG. 3, the information DB 121 has items, such as “row”, “item”, “value”, “standardized vocabulary”, and “group”. The information DB 121 stores therein information as a single record for, for example, each cell that constitutes the table data.

The “row” is information indicating a row of a cell in which data is input, i.e., indicating the row number of data. The “item” is information indicating an item associated with a cell, i.e., an item name. The “value” is information indicating data stored in a cell. The “standardized vocabulary” is information indicating a standardized vocabulary associated with the item, i.e., the item name. The “group” is information indicating a group to which a standardized vocabulary belongs. Furthermore, the group is also referred to as an item group. In the example of the first row illustrated in FIG. 3, the value of the item “x1” at the “first” row in the table data indicates “y1”, the standardized vocabulary associated with the item “x1” is “B01”, and the associated group is “G02”. Furthermore, in the explanation of FIG. 3, the items, the values, the standardized vocabularies, and the groups are simply represented by symbols and numeric figures; however, in practice, specific characters or the like are input. For example, in a certain record, the item “address”, the value “Tokyo . . . ”, the standardized vocabulary “address”, and the group “common” are associated with each other and stored.

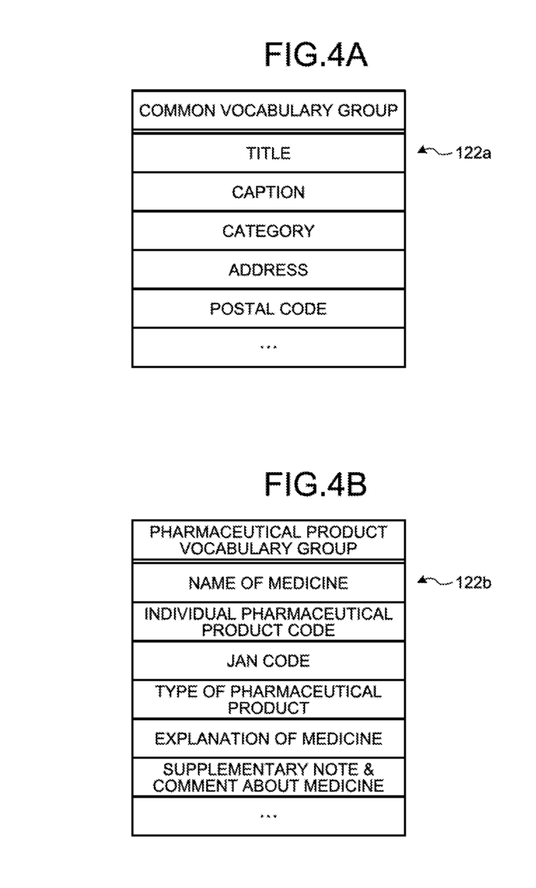

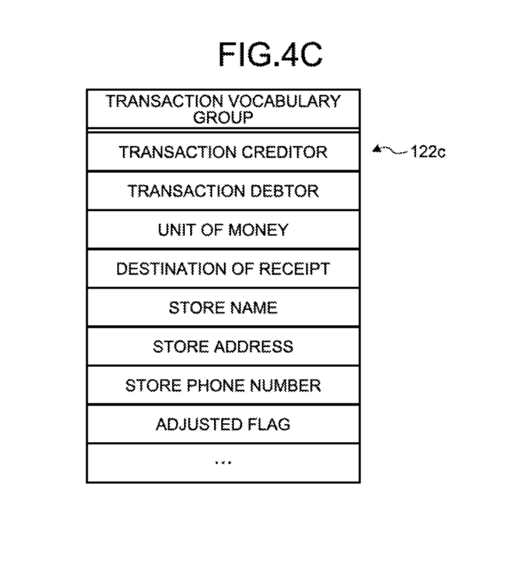

A description will be given here by referring back to FIG. 1. The vocabulary DB 122 stores therein standardized vocabularies for each group. FIG. 4A is a diagram illustrating an example of the vocabulary DB. FIG. 4A indicates, from among standardized vocabularies, a group that stores therein common vocabularies that are common to all types of industry. As illustrated in FIG. 4A, a common vocabulary group 122a in the vocabulary DB 122 stores therein, together with the group name “common vocabulary group”, for example, vocabularies, such as “title” and “caption”, that are common to all types of industry. Furthermore, the group name may also be abbreviated to “common”. Furthermore, if an existing database is present, the vocabulary DB 122 may also acquire the database or, if an existing database is not present, a new database may also be created.

FIG. 4B is a diagram illustrating an example of the vocabulary DB. FIG. 4B indicates, from among standardized vocabularies, a pharmaceutical product vocabulary group that is an example of a group in which a vocabulary for each type of industry is stored. As illustrated in FIG. 4B, a pharmaceutical product vocabulary group 122b in the vocabulary DB 122 stores therein, together with the group name “pharmaceutical product vocabulary group”, for example, vocabularies, such as “name of medicine” and “individual pharmaceutical product code”, that are common to pharmaceutical products. Furthermore, the group name may also be abbreviated to “pharmaceutical product”.

FIG. 4C is a diagram illustrating an example of the vocabulary DB. FIG. 4C indicates, from among standardized vocabularies, a transaction vocabulary group that is an example of a group in which a vocabulary for type of industry is stored. As illustrated in FIG. 4C, a transaction vocabulary group 122c in the vocabulary DB 122 stores therein, together with the group name “transaction vocabulary group”, for example, vocabularies, such as “transaction creditor” and “transaction debtor”, that are common to transactions. Furthermore, the group name may also be abbreviated to “transaction”. Furthermore, the common vocabulary group 122a, the pharmaceutical product vocabulary group 122b, and the transaction vocabulary group 122c are an example of a predetermined item group.

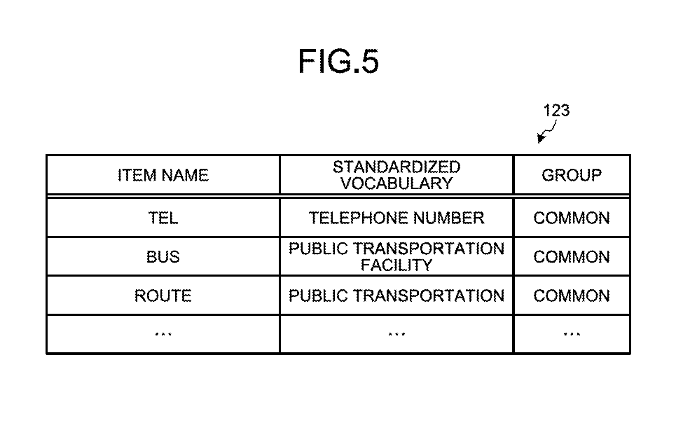

A description will be given here by referring back to FIG. 1. The history DB 123 stores therein history obtained by being association in the past at manual determination. FIG. 5 is a diagram illustrating an example of the history DB. As illustrated in FIG. 5, the history DB 123 has items, such as “item name”, “standardized vocabulary”, and “group”. The history DB 123 stores therein information as a single record for, for example, each item name. In other words, the history DB 123 stores therein the association relationship between an adopted candidate and the item name from which a negative determination result has been obtained. Furthermore, by using the history of all of the users, the history DB 123 can submit more appropriate standardized vocabulary.

The “item name” is information indicating an item name that is extracted from the table format data and that has been subjected to manual determination. The “standardized vocabulary” is information indicating an adopted standardized vocabulary as the result of manual determination. The “group” is information indicating a group to which the standardized vocabulary belongs. The example on the first row illustrated in FIG. 5 indicates that the standardized vocabulary “phone number” belonging to the group “common” has been adopted with respect to the item name “TEL” at manual determination.

A description will be given here by referring back to FIG. 1. The control unit 130 is implemented by, for example, a central processing unit (CPU), a micro processing unit (MPU), or the like executing, in a RAM as a work area, the program that is stored in an inner storage device. Furthermore, the control unit 130 may also be implemented by, for example, an integrated circuit, such as an application specific integrated circuit (ASIC), a field programmable gate array (FPGA), or the like.

The control unit 130 includes a determination unit 131, an extracting unit 132, an editing unit 133, a count unit 134, a creating unit 135, a detection unit 136, a specifying unit 137, and a storage control unit 138. Furthermore, the control unit 130 includes an item group determination unit 139, a submitting unit 140, and an association relationship storage control unit 141 and implements or performs the function or the operation of the information processing described below. Furthermore, the internal configuration of the control unit 130 is not limited to the configuration illustrated in FIG. 1 and may also be another configuration as long as the information processing, which will be described later, is performed.

If the table format data is input from the communication unit 110, the determination unit 131 determines, regarding each row or each column of the input table format data, whether or not a cell in which data has been input is present. Namely, the determination unit 131 determines whether or not a data input cell is present in the table format data. The determination unit 131 outputs the table format data and the determination result to the extracting unit 132.

If the table format data and the determination result are input from the determination unit 131, the extracting unit 132 extracts, based on the determination result, from the table format data, a chunk of a plurality of consecutive rows or columns in each of which the data input cell is present to a single piece of table data as a correlated portion. Namely, if the extracting unit 132 detects, between both sides of a single or a plurality of consecutive rows or columns in each of which a data input cell is not present, two chunks of a single or a plurality of consecutive rows or columns in each of which a data input cell is present, the extracting unit 132 extracts each of the two chunks as different pieces of table data. When extracting the table data, the extracting unit 132 outputs the extracted table data as first table data to the editing unit 133 and the creating unit 135. Furthermore, the extracting unit 132 stores the first table data in the storage unit 120.

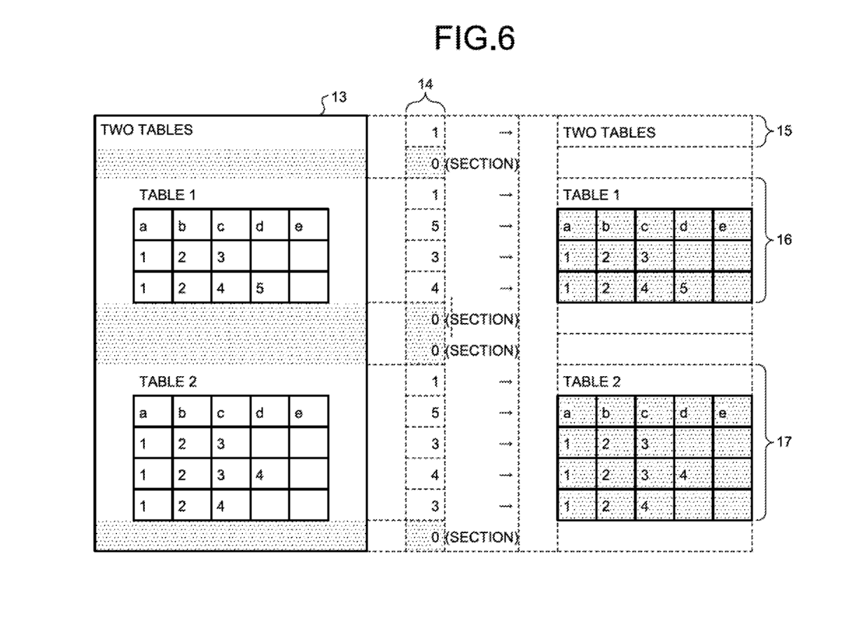

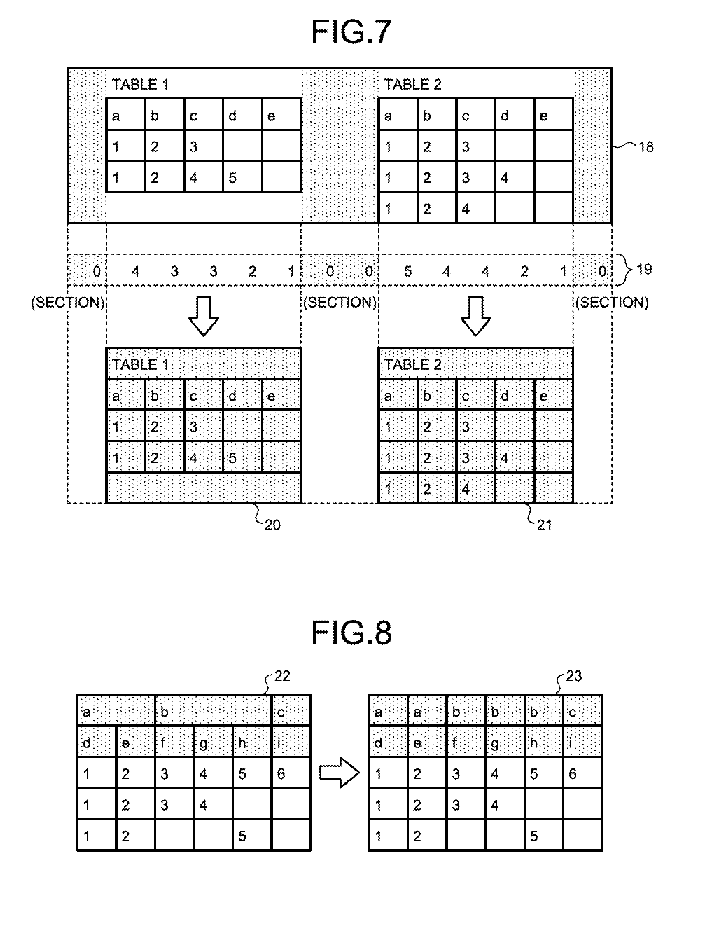

In the following, extracting table data will be described with reference to FIGS. 6 and 7. FIG. 6 is a diagram illustrating an example of extracting table data. FIG. 6 is an example of a case in which a plurality of pieces of table data is present in the vertical direction. In the example illustrated in FIG. 6, regarding table format data 13, the extracting unit 132 detects a data input number 14, which corresponds to the number of pieces of input data, in each row. For example, in the table format data 13, because the title of the table format data 13 is input to a single cell in the first row, the data input number 14 indicates “1”. Furthermore, in the second row, because a cell in which data is input is not present, the data input number 14 indicates “0”. In the same manner, the extracting unit 132 detects the data input number 14 in each row.

The extracting unit 132 determines that the row in which the data input number 14 is “0” is a section of the table data and divides the table format data 13 at the section. In a description below, the chunk that is a portion related to the divided table data is also referred to as a cluster. The table format data 13 is divided into a cluster 15, a cluster 16, and a cluster 17. The cluster 15 is the title of the table format data 13. The cluster 16 is table data 1. The cluster 17 is table data 2. The extracting unit 132 extracts the cluster 16 and the cluster 17 as the first table data. Furthermore, the extracted first table data is converted to a table format by using, for example, two-dimensional array in a memory.

Furthermore, in a description below, the same applies to each of the pieces of the table data based on the first table data.

FIG. 7 is a diagram illustrating another example of extracting table data. FIG. 7 is an example of a case in which a plurality of pieces of table data is present in the lateral direction. In the example illustrated in FIG. 7, regarding table format data 18, the extracting unit 132 detects a data input number 19, which corresponds to the number of pieces of input data, in each column. For example, in the table format data 18, because a cell in which data is input is not present in the first column, the data input number 19 indicates “0”. Furthermore, on the second column, because the title of the table format data 18 is input to the first row, “a” is input to the second row, “1” is input to the third row, and “1” is input to the fourth row 4, the data input number 19 indicates “4”. In the same manner, the extracting unit 132 detects the data input number 19 in each column.

The extracting unit 132 determines that the column, in which the data input number 19 is “0”, as a section of the table data and divides the table format data 18 at the section. The table format data 18 is divided into a cluster 20 and a cluster 21. The cluster 20 is the table data 1. The cluster 21 is table data 2. The extracting unit 132 extracts the cluster 20 and the cluster 21 as the first table data. Furthermore, when compared with the cluster 21, in the cluster 20, a data input cell is not present in the fifth row; however, by adding null characters on the fifth row, the size of the table is made the same.

A description will be given here by referring back to FIG. 1. If the first table data is input from the extracting unit 132, the editing unit 133 performs an editing process on the input first table data. First, from among the cells constituting a table except for the title cell in the first table data, the editing unit 133 temporarily decides the uppermost row or the leftmost column as the item row or the item column, respectively. Furthermore, the title cell can be determined, in the first table data, the uppermost or the leftmost row or column in which the data input number used by the extracting unit 132 is “1”. If a specific cell that has been subjected to cell concatenation process is included in the temporarily decided item row or the item column, the editing unit 133 divides the specific cell into a unit cell. Furthermore, the editing unit 133 inputs the same data as the data that was input to each of the specific cells of the divided unit cells. The editing unit 133 outputs the table data that has been subjected to the editing process to the count unit 134 and the creating unit 135 as second table data. Furthermore, if the specific cell that has been subjected to the cell concatenation process is not included in the temporarily decided item row or the item column, the editing unit 133 outputs the input first table data to the count unit 134 and the creating unit 135 as the second table data without processing anything.

In the following, the editing process will be described with reference to FIGS. 8 to 11. FIG. 8 is a diagram illustrating an example of the editing process. In the example illustrated in FIG. 8, the cell that has been subjected to the cell concatenation process is included in the first row in first table data 22. Namely, the cells each having the value of “a” or “b” are the specific cells that have been subjected to the cell concatenation process. The editing unit 133 divides the specific cell into unit cells and inputs the value of “a” or “b” to each of the divided unit cells. The editing unit 133 outputs second table data 23 that has been subjected to the editing process to the count unit 134 and the creating unit 135.

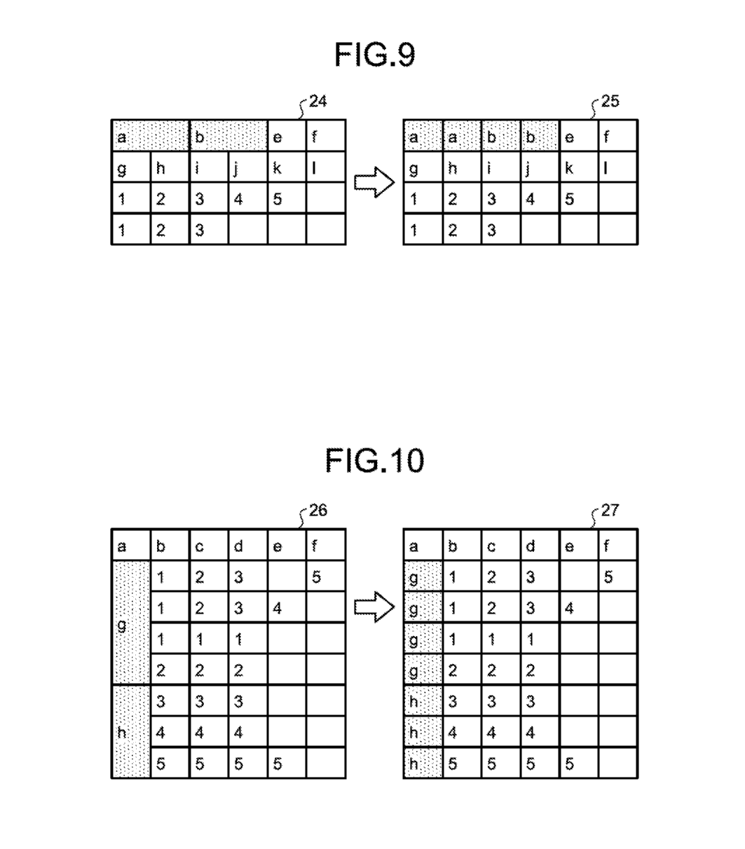

FIG. 9 is a diagram illustrating another example of the editing process. In the example illustrated in FIG. 9, similarly to the example illustrated in FIG. 8, the value of “a” or “b” at the specific cells subjected to the cell concatenation process in first table data 24 is input to each of the divided unit cells and second table data 25 is created.

FIG. 10 is a diagram illustrating another example of the editing process. In the example illustrated in FIG. 10, the cells that have been subjected to the cell concatenation process are included in the first column in first table data 26. Namely, the cells having the value of “g” or “h” are specific cells that have been subjected to the cell concatenation process. The editing unit 133 divides the specific cell into unit cells and inputs the value “g” or “h” to each of the divided unit cells. The editing unit 133 outputs second table data 27 that has been subjected to the editing process to the count unit 134 and the creating unit 135. Namely, the editing unit 133 divides the specific cell that has been subjected to the cell concatenation process in the row direction and the specific cell that has been subjected to the cell concatenation process in the column direction into unit cells and then inputs a value of a specific cell to each of the divided unit cells.

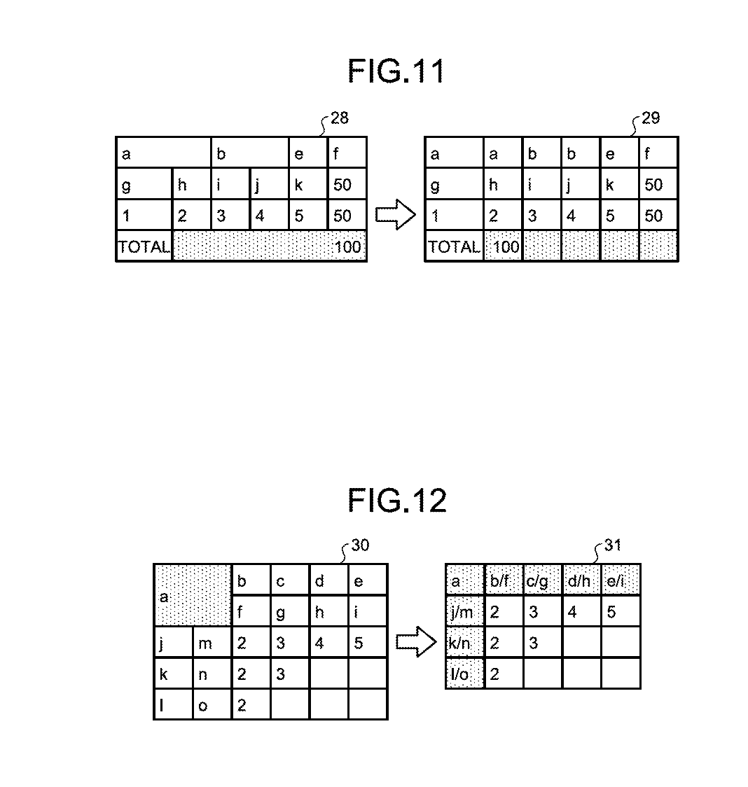

FIG. 11 is a diagram illustrating an example of de-concatenation of cells that are present in a row other than an item row. In the example illustrated in FIG. 11, in the bottom row in first table data 28, i.e., in the fourth row, the cells that have been subjected to the cell concatenation process are included. Namely, the cell with the value of “100” is the specific cell that has been subjected to the cell concatenation process. Because the bottom row in the first table data 28 is not an item row, the editing unit 133 divides the specific cell into unit cells and inputs the value of “100” to one of the divided unit cells. The editing unit 133 outputs second table data 29 in which the editing process has been completed to the count unit 134 and the creating unit 135. Furthermore, in the example illustrated in FIG. 11, a description of releasing the concatenation process on the first cell is omitted. Furthermore, de-concatenation of the cell included in the row that is not an item row may also be performed after an item row or an item column is specified by the specifying unit 137.

A description will be given here by referring back to FIG. 1. If the second table data is input from the editing unit 133, the count unit 134 counts, in the second table data, for each row or column, the number of cells in which data has been input. Namely, the count unit 134 counts, for each row or column from among a chunk of rows or columns, the number of cells in each of which data has been input. The count unit 134 outputs the number of cells counted for each row or column as a count value to the detection unit 136.

In the creating unit 135, the first table data is input from the extracting unit 132 and the second table data is input from the editing unit 133. First, the creating unit 135 temporarily decides, in the input first table data, from among the cells constituting the table except for the title cell, the uppermost row or the leftmost column as the item row or the item column, respectively. Furthermore, the title cell can be determined by the same way as that used by the editing unit 133. If a specific cell that has been subjected to the cell concatenation process is included in the temporarily decided item row or the item column, the creating unit 135 temporarily decides that the range including the specific cell as a plurality of consecutive item rows or item columns. Namely, the creating unit 135 temporarily decides a row or a column in which each of the unit cells obtained by dividing the specific cell is included and the row or the column adjacent to the subject row or the column that is present on the lower side or the right side as the plurality of consecutive item rows or item columns.

If the creating unit 135 temporarily decides the plurality of consecutive item rows or item columns, the creating unit 135 creates the item name of the second table data that is input from the editing unit 133. Namely, regarding the temporarily decided plurality of consecutive item rows or item columns, the creating unit 135 creates, as an item name, the value obtained by combining of the value of the same column or the concatenation cell including the cells on the same column and the value of the same row or the concatenation cell including the cells on the same rows as the combined value. Furthermore, the concatenation cell means the specific cell that has been subjected to the cell concatenation process. The creating unit 135 outputs the second table data in which the created item name is used to the detection unit 136 as the third table data. If the specific cell that has been subjected to the cell concatenation process is not included in the temporarily decided item row or the item column, the creating unit 135 outputs the input second table data to the detection unit 136 as third table data.

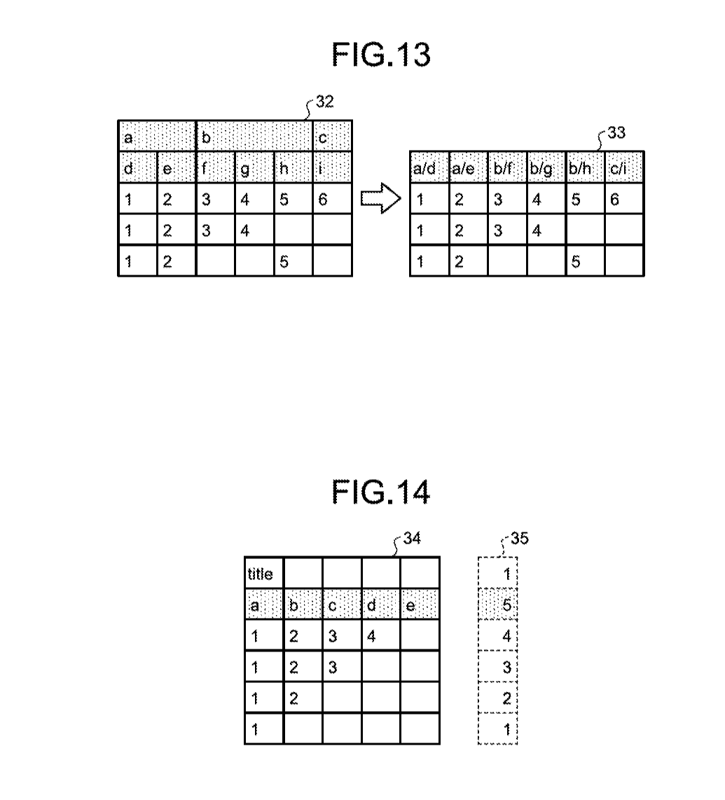

In the following, creating an item name will be described with reference to FIGS. 12 and 13. FIG. 12 is a diagram illustrating an example of creating item names. In the example illustrated in FIG. 12, regarding first table data 30, the creating unit 135 temporarily decides the first and the second rows as an item row and temporarily decides the first and the second columns as an item column. Then, on the first and the second rows, the creating unit 135 creates the value obtained by combining the values of the cells in the same columns or the concatenation cells including the same columns as each of the item names of the item row. Furthermore, the combined value is created based on the second table data (not illustrated) in which the cell concatenation process has been reset regarding the specific cell that has been subjected to the cell concatenation process. The creating unit 135 creates, for example, “b/f” obtained by combining “b” at the first row and the third column and “f” at the second row and the third column in the first table data 30 as the item name of the first row and the second column in third table data 31.

Furthermore, in the first and the second columns, the creating unit 135 creates the value obtained by combining the value of the cells in the same rows or the concatenation cell including the same rows as each of the item names of the item columns. The creating unit 135 creates, for example, “j/m” obtained by combining “j” at the third row and the first column and “m” at the third row and the second column in the first table data 30 as the item name of the second row and the first column in the third table data 31. Furthermore, in the first table data 30, the four cells at the first row and the first column, at the first row and the second column, at the second row and the first column, and the second row and the second column are concatenated and the value thereof is “a”; therefore, in the third table data 31, the item name of the first row and the first column is set to “a”.

FIG. 13 is a diagram illustrating another example of creating item names. In the example illustrated in FIG. 13, regarding first table data 32, the creating unit 135 temporarily decides the first and the second rows as the item rows. Then, the creating unit 135 creates, in the first and the second rows, the value obtained by combining the values of the cells in the same column or the concatenation cell including the same column as each of the item names of the item rows. Furthermore, the combined value is created based on the second table data (not illustrated) in which the cell concatenation process has been reset regarding the specific cell that has been subjected to the cell concatenation process. The creating unit 135 creates, for example, “a/d” obtained by combining “a” at the first row and the first column and “d” at the second row and the first column in the first table data 32 as the item name of the first row and the first column in third table data 33. Furthermore, the creating unit 135 creates, for example, “a/e” obtained by combining “a” at the first row and the second column and “e” at the second row and the second column in the first table data 32 as the item name of the first row and the second column in the third table data 33.

A description will be given here by referring back to FIG. 1. In the detection unit 136, a count value is input to the count unit 134 and the third table data is input to the creating unit 135. The detection unit 136 detects, with respect to the input third table data, from among the rows or the columns in which the input count value is the maximum, the uppermost row or the leftmost column. The detection unit 136 outputs the detected uppermost row or the leftmost column to the specifying unit 137 as the detection result together with the count value and the third table data.

In the specifying unit 137, the detection result, the count value, and the third table data are input to the detection unit 136. The specifying unit 137 specifies, based on the count value and the third table data, from among the rows or the columns in which the input count value is the maximum, the uppermost row or the leftmost column as the row or the column that indicates the item of the table. Namely, the specifying unit 137 specifies the item row or the item column. The specifying unit 137 sets the specified third table data as fourth table data. The specifying unit 137 outputs the specified item row or the item column and the fourth table data to the storage control unit 138.

Furthermore, the specifying unit 137 may also specify the item row or the item column based on the detection result, the count value, and the third table data. If the count value associated with the row that is adjacent to and on the lower side of the detected uppermost row is not the maximum, the specifying unit 137 specifies the uppermost row as the row that indicates the item of the table. Alternatively, if the count value associated with the column that is adjacent to and on the right side of the detected leftmost column is not the maximum, the specifying unit 137 specifies the leftmost column as the column that indicates the item of the table. Namely, the specifying unit 137 specifies an item row or an item column. The specifying unit 137 sets the third table data that has been specified to the fourth table data. The specifying unit 137 outputs the specified item row or the item column and the fourth table data to the storage control unit 138.

Furthermore, if a plurality of rows has the same count value, the specifying unit 137 may also specify an item row or an item column based on a percentage of the cells in each of which non-numeric data has been input. If the detected uppermost row is included and a plurality of consecutive rows has the same count value, the specifying unit 137 specifies the row indicating the item based on a percentage of the cells in each of which non-numeric data has been input from among the cells included in the plurality of rows. Alternatively, if the detected leftmost column is included and a plurality of consecutive columns has the same count value, the specifying unit 137 specifies as the column indicating the item based on a percentage of the cells in each of which non-numeric data has been input from among the cells included in the plurality of columns. Namely, the specifying unit 137 specifies an item row or an item column. The specifying unit 137 sets the third table data in which the specifying process has been completed to the fourth table data. The specifying unit 137 outputs the specified item row or the item column and the fourth table data to the storage control unit 138.

Furthermore, the specifying unit 137 may also specify an item row or an item column by using the item row or the item column that has temporarily been decided by the editing unit 133. Furthermore, the specifying unit 137 may also specify an item row or an item column by using the plurality of consecutive item rows or item columns that have temporarily been decided by the creating unit 135. The specifying unit 137 sets the third table data in which the specifying process has been completed to the fourth table data. The specifying unit 137 outputs the specified item row or the item column and the fourth table data to the storage control unit 138.

Furthermore, if the third table data is not the table in which an item row or an item column is not present, the specifying unit 137 may also specify an item row or an item column by identifying the uppermost row or the leftmost column as an item row or an item column, respectively. Even if, from among the rows or the columns in which a count value is the maximum, the uppermost row or the leftmost column includes the cell in which input data is not an item name, the specifying unit 137 specifies the uppermost row or the leftmost column as the item row or the item column. The specifying unit 137 sets the third table data in which the specifying process has been completed to the fourth table data. The specifying unit 137 outputs the specified item row or the item column and the fourth table data to the storage control unit 138.

Furthermore, if the input data includes a duplicate cell, the specifying unit 137 may also add a new item row or a new item column. Regarding the uppermost row or the leftmost column out of the rows or the columns in each of which the count value is the maximum, if input data includes a duplicate cell, the specifying unit 137 adds a new row or a new column on the further upper side of the uppermost row or on the further left side of the leftmost column. The specifying unit 137 specifies the added row or the column as the item row or the item column, respectively. The specifying unit 137 sets the third table data in which the specifying process has been completed and a new row or a new column has been added to the fourth table data. The specifying unit 137 outputs the specified item row or the item column and the fourth table data to the storage control unit 138.

Furthermore, if the uppermost row or the leftmost column includes a blank cell, the specifying unit 137 may also add a new item row or a new item column. Furthermore, a blank cell is represented by a null character (NULL). If the uppermost row or the leftmost column out of the row or the column in which the count value is the maximum includes a blank cell, the specifying unit 137 adds a new row or a new column on the further upper side of the uppermost row or on the further left side of the leftmost column. The specifying unit 137 specifies the added row or the column as the item row or the item column, respectively. The specifying unit 137 sets the third table data in which the specifying process has been completed and a new row or a new column has been added to the fourth table data. The specifying unit 137 outputs the specified item row or the item column and the fourth table data to the storage control unit 138.

In the following, specifying an item row will be described with reference to FIGS. 14 to 22. FIG. 14 is a diagram illustrating an example of specifying an item row. The example illustrated in FIG. 14 is a case of specifying an item row when the number of rows with the maximum count value is one. In third table data 34, for count values 35, the second row indicates “5” and has the maximum value. The specifying unit 137 specifies the second row as the item row because the count value in the third row that is adjacent to and on the lower side of the second row indicates “4” and is not the maximum.

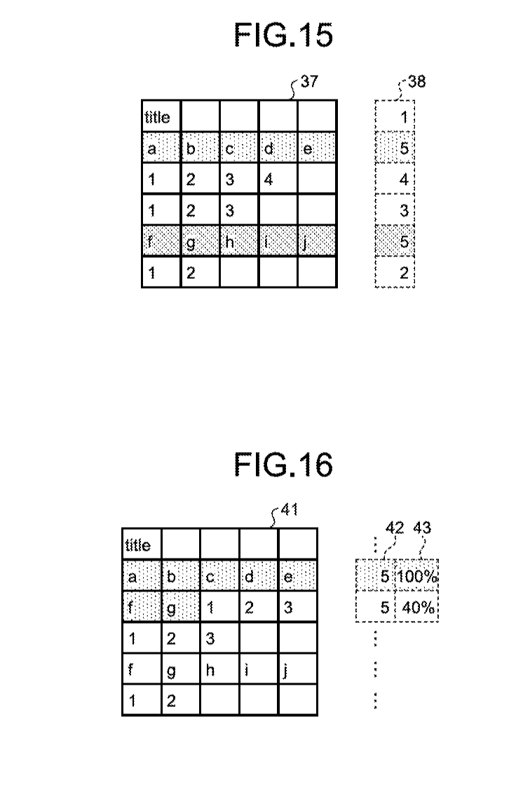

FIG. 15 is a diagram illustrating another example of specifying item rows. The example illustrated in FIG. 15 is a case of specifying the item row when a plurality of rows with the maximum count value is present. In third table data 37, for count values 38, each of the second row and the fifth row indicate “5” and has the maximum value. The specifying unit 137 specifies the second row that is the uppermost row as the item row from among the rows each having the maximum count value.

FIG. 16 is a diagram illustrating another example of specifying item rows. The example illustrated in FIG. 16 is a case of specifying the item row based on a percentage of the cells in each of which non-numeric data has been input. In third table data 41, for count values 42, each of the second row and the third row indicate “5” and has the maximum value. Furthermore, the count values 42 indicated in the other rows are omitted. Furthermore, in the third table data 41, regarding a percentage 43 indicated in each cell in which non-numeric data has been input, the second row indicates 100% and the third row indicates 40%. The specifying unit 137 determines whether the percentage in the third row that is adjacent to the second row is equal to or greater than, for example, 50%. Because the percentage indicated in the third row is 40%, the specifying unit 137 determines that the third row is not the item row and specifies that the second row is the item row.

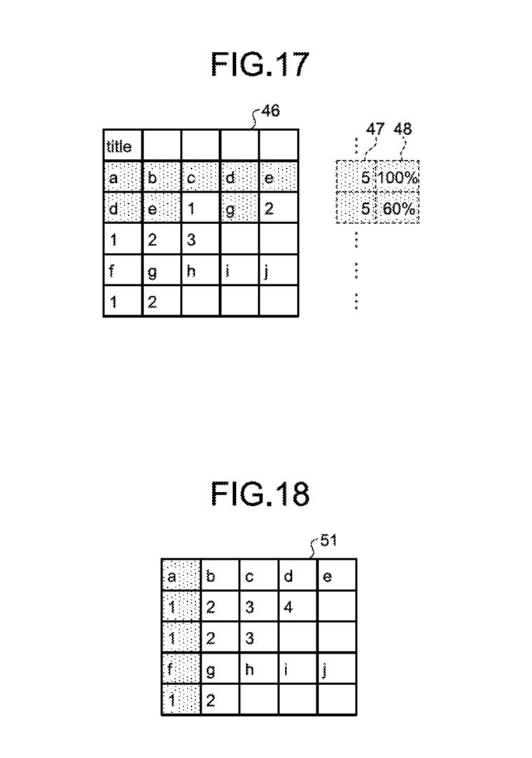

FIG. 17 is a diagram illustrating another example of specifying item rows. The example illustrated in FIG. 17 is a case of specifying the item row based on a percentage of the cells in each of which non-numeric data has been input. In third table data 46, for count values 47, each of the second row and the third row indicate “5” and has the maximum value. Furthermore, the count values 47 indicated in the other rows are omitted. Furthermore, in the third table data 46, regarding a percentage 48 indicated in each cell in which non-numeric data has been input, the second row indicates 100% and the third row indicates 60%. The specifying unit 137 determines whether the percentage in the third row adjacent to the second row is equal to or greater than, for example, 50%. Because the percentage indicated in the third row is 60%, the specifying unit 137 determines that the third row is the item row and specifies that the second and the third rows are the item rows. Furthermore, the value data entered in the item row is, for example, the number of methods of transportation.

FIG. 18 is a diagram illustrating an example of specifying an item column. The example illustrated in FIG. 18 is a case of specifying the item column assuming that the leftmost column is the item column when the item column is not present in the table. In third table data 51, the first row is the item row; however, data is input in the cells at the first column and the second and the subsequent rows. In this case, the specifying unit 137 specifies that the first column is the item column assuming the first column that is the leftmost column as the item column.

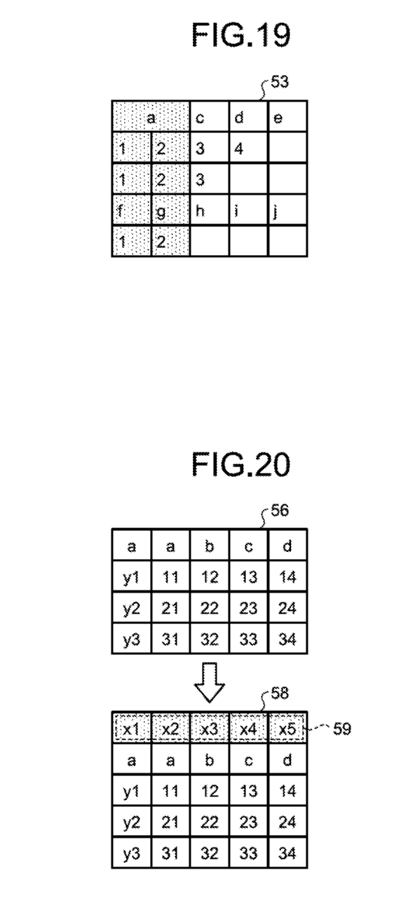

FIG. 19 is a diagram illustrating another example of specifying item columns. The example illustrated in FIG. 19 is a case of specifying the item column assuming the leftmost column as the item column when the item column is not present in the table. In first table data 53, the first row is the item row; however, data is input in the cells at the first column and the second and the subsequent rows. Furthermore, the first table data 53 is a specific cell obtained by concatenating the cell at one row by one column and the cells at one row by two columns. In this case, because the specific cell is included in the first column, the specifying unit 137 assumes that the column that includes the specific cell, i.e., the first column and the second column, as the item column and specifies that the first and the second columns are the item column. Furthermore, in addition to the detection results, the count values, and the third table data, the specifying unit 137 specifies the item column by referring to the first table data stored in the storage unit 120.

FIG. 20 is a diagram illustrating an example of adding an item row. The example illustrated in FIG. 20 is a case of adding a new item row or a new item column when input data includes a duplicate cell. In third table data 56, data at the first row and the first column and data at the first row and the second column indicate “a” and the data in which an input has been received and that is located in the first row includes a duplicate cell. In this case, the specifying unit 137 further adds a new row on the upper side of the uppermost row and sets the obtained data as fourth table data 58. The specifying unit 137 specifies an added row 59 in the fourth table data 58 as the item row.

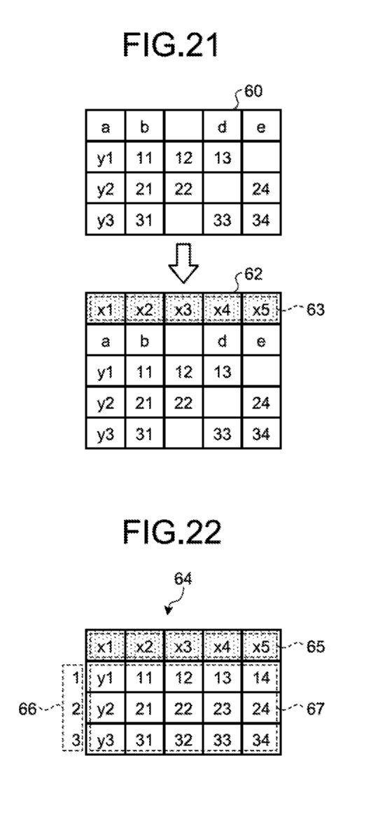

FIG. 21 is a diagram illustrating another example of adding an item row. The example illustrated in FIG. 21 is a case of adding a new item row when the uppermost row includes a blank cell. In third table data 60, the cell at the first row and the third column is blank. In this case, the specifying unit 137 further adds a new row on the upper side of the uppermost row and sets as fourth table data 62. The specifying unit 137 specifies the row 63 added to the fourth table data 62 as the item row. Furthermore, the third table data 60 is a case in which blank cells are present in the other rows and the count value at the first row is included in the maximum row. In such a case, because the second and the subsequent rows are not erroneously identified as the item row, the third table data 60 can be used.

FIG. 22 is a diagram illustrating an example of table data after shaping. Fourth table data 64 illustrated in FIG. 22 is a table data obtained after the item row or the item column has been specified by the specifying unit 137, i.e., a shaped table. The fourth table data 64 has an item row 65, a data row number 66, and a data portion 67. Namely, the fourth table data 64 is in the state in which, associating both the number of rows and the item names with each of the pieces of data (cell value) has been performed. Furthermore, the data row number 66 does not need to be included in the fourth table data 64 and the number of rows may also be counted and added when data is stored in the information DB 121.

A description will be given here by referring back to FIG. 1. In the storage control unit 138, the specified item row or the item column and the fourth table data are input from the specifying unit 137. Based on the specified item row or the item column and based on the fourth table data, the storage control unit 138 uses the data input to each of the cells at the item row or the item column as the item name, associates the value of each of the rows or each of the columns with both the item name and the data row number, and stores the associated data in the information DB 121. When the storage control unit 138 associates the data row numbers, the item names, and the values and stores the associated data in the information DB 121, the storage control unit 138 outputs a determination instruction to the item group determination unit 139. Furthermore, each of the units from the determination unit 131 to the storage control unit 138 corresponds to an item name extracting unit that extracts, as the item name, the data input to each of the cells at the item row or the item column specified from the table format data.

When the determination instruction is input from the storage control unit 138, the item group determination unit 139 refers to the information DB 121, the vocabulary DB 122, and the history DB 123 and determines the item group (group) associated with each of the item names. Namely, the item group determination unit 139 refers to the vocabulary DB 122 and the history DB 123 in which a plurality of item groups is stored and determines which item group includes the item name having a predetermined similar relationship with each of the plurality of item names stored in the information DB 121.

Specifically, the item group determination unit 139 sequentially reads item names from, for example, the first record in the information DB 121 and shapes the item names. The item group determination unit 139 shapes the item names by removing, from the read item names, for example, an annotation element, such as parentheses, or a blank before or after the item name. When reading the item name of, for example, “public transportation facility (JR)”, the item group determination unit 139 shapes the read item name to “public transportation facility”.

The item group determination unit 139 refers to the vocabulary DB 122, uses the shaped item name, and performs matching with the standardized vocabulary. The item group determination unit 139 determines whether the item name is matched to the standardized vocabulary. At the time of matching, if the item name and a standardized vocabulary are perfectly matched or partially matched, the item group determination unit 139 determines that both are matched. When, for example, the item name is “public transportation facility”, if the standardized vocabulary is “public transportation facility”, the item group determination unit 139 determines that this indicates a perfect matching and, if the standardized vocabulary is “transportation facility”, the item group determination unit 139 determines that this indicates a partial matching.

If the item name is matched to the standardized vocabulary, the item group determination unit 139 adopts the matched standardized vocabulary. The item group determination unit 139 stores the adopted standardized vocabulary and the group to which the standardized vocabulary belongs in the information DB 121.

If the item name is not matched to the standardized vocabulary, the item group determination unit 139 checks the item name in the history DB 123. Namely, the item group determination unit 139 performs matching the item name on the association history of the past manual determination. The item group determination unit 139 determines whether the item name is matched to the item name in the history DB 123. At this time, if the item name is perfectly matched to the item name in the history DB 123, the item group determination unit 139 determines that both are matched. When, for example, the item name is “bus”, the item group determination unit 139 determines, at the matching, that the item name is perfectly matched to the item name of “bus” in the history DB 123.

If the item name is matched to the item name in the history DB 123, the item group determination unit 139 adopts the standardized vocabulary in the history DB 123. For example, the item group determination unit 139 adopts the standardized vocabulary “public transportation facility” that is associated with the item name “bus” in the history DB 123. The item group determination unit 139 stores the adopted standardized vocabulary and the group to which the standardized vocabulary belongs in the information DB 121. If the item name is not matched to the item name in the history DB 123, the item group determination unit 139 adds the item name to a manual determination stock. Furthermore, the manual determination stock is a storage area provided in the storage unit 120.

In other words, the item group determination unit 139 refers to the vocabulary DB 122 and the history DB 123 and determines which group (item group) includes the standardized vocabulary that has a predetermined similar relationship with the item name that is perfectly matched or partially matched. If a positive determination result has been obtained, the item group determination unit 139 stores the adopted standardized vocabulary and the group to which the standardized vocabulary belongs in the information DB 121. If a negative determination result has been obtained, the item group determination unit 139 does not store the standardized vocabulary and the group in the information DB 121. Furthermore, the history DB 123 to be referred to may also be used as a database that stores therein history in accordance with a group for each type of industry. In this case, the item group determination unit 139 can determine, with priority, the history of the subject type of industry.

The item group determination unit 139 determines whether matching has been completed on all of the item names. If matching has not been completed on all of the item names, the item group determination unit 139 repeats matching on the item name of the subsequent records in the information DB 121. If matching has been completed on all of the item names, the item group determination unit 139 outputs a submission instruction to the submitting unit 140.

If the submission instruction is input from the item group determination unit 139, regarding the item name in which a positive determination result has been obtained, i.e., the item name related to the standardized vocabulary and the group that are stored in the information DB 121, the submitting unit 140 selects the stored standardized vocabulary as the association target. Namely, regarding the item name, the submitting unit 140 automatically selects the standardized vocabulary stored in the vocabulary DB 122 or the history DB 123. The submitting unit 140 outputs the selected standardized vocabulary and the group together with the associated item names to the association relationship storage control unit 141.

Regarding the item name from which a negative determination result has been obtained, i.e., regarding the item name stored in the manual determination stock, the submitting unit 140 submits, as an association candidate, the group that includes the standardized vocabulary that has a predetermined similar relationship indicating that the group that has perfectly matched or partially matched to another item name in the table. Namely, regarding the item name stored in the manual determination stock, the submitting unit 140 sends an allocation screen for submitting a standardized vocabulary candidate, i.e., an association candidate, to a terminal device (not illustrated) via the communication unit 110 and displays the screen on the terminal device.

The submitting unit 140 receives selection information from the terminal device (not illustrated) via the communication unit 110. The submitting unit 140 receives the selection information and outputs the received selection of the standardized vocabulary and the group to the association relationship storage control unit 141 together with the associated item name.

Furthermore, when submitting the association candidate, the submitting unit 140 may also further submit a predetermined item group as another association candidate. The submitting unit 140 may also submit, for example, in addition to the standardized vocabulary belonging to a group “pharmaceutical product”, a standardized vocabulary that belongs to a group “common” as an association candidate.

Furthermore, if a plurality of item names is extracted from a plurality of tables that are detected from the table format data, the submitting unit 140 may also submits, as an association candidate, a group that includes the item name that has a predetermined similar relationship with another item name that was extracted from the same table out of the plurality of tables. Namely, the submitting unit 140 may also submit, as an association candidate, the group that includes a standardized vocabulary that is perfectly matched or partially matched with another item name that was extracted from the same table.

Furthermore, the submitting unit 140 may also submit, with priority, the group to which the standardized vocabulary that is matched with another item name included in the same table. Namely, if it is determined that a first item name having a predetermined similar relationship with the item name that is included in the same table that includes the item name from which a negative determination result has been obtained is included and if it is determined that the item name having a predetermined similar relationship with a second item name included in a table that is different from a table that includes the item name from which the negative determination result has been obtained is included, the submitting unit 140 submits, regarding the item name from which the negative determination result has been obtained, the item group that includes the first item name as an association candidate with priority over the item group that includes the second item name.

Furthermore, if the item name extracted from the table format data or another table format data is associated with a specific item name by the association relationship stored in the history DB 123, the submitting unit 140 may also select the specific item name as the association target. Furthermore, the specific item name is the standardized vocabulary related to the association relationship.

Furthermore, when the submitting unit 140 submits the association candidate of another item name from which a negative determination result has been obtained, the submitting unit 140 may also submit the item group that includes a specific item name (standardized vocabulary related to the association relationship) with priority over another item group as an association candidate.

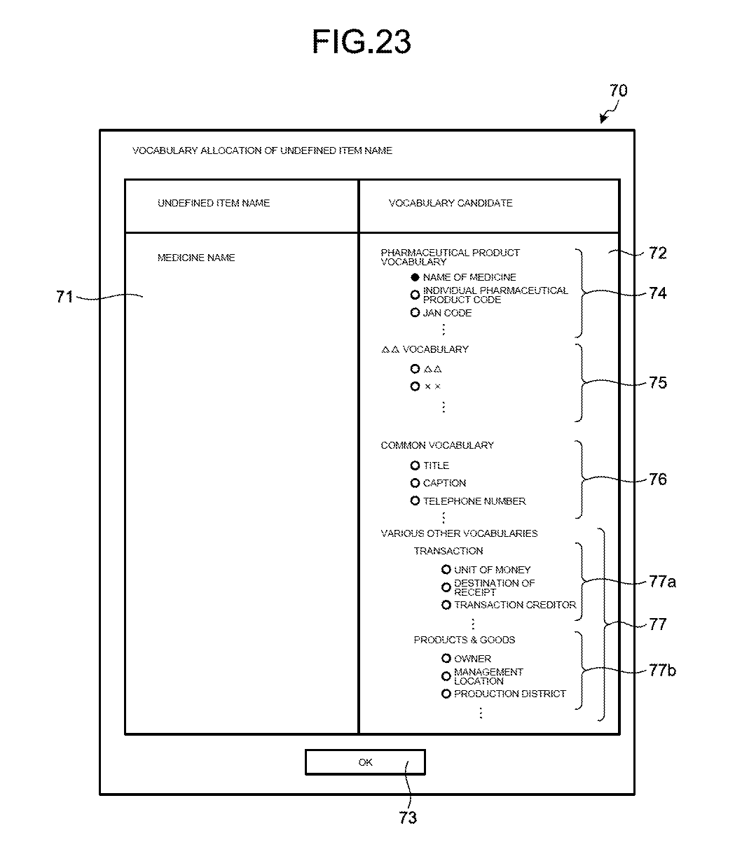

In the following, an example of an allocation screen will be described with reference to FIG. 23. FIG. 23 is a diagram illustrating an example of the allocation screen. As illustrated in FIG. 23, an allocation screen 70 includes an undefined item name field 71, a vocabulary candidate field 72, and an ok button 73. In the undefined item name field 71, the item name stored in the manual determination stock, i.e., the item name associated with standardized vocabulary that is undefined. In the vocabulary candidate field 72, an association candidate of a standardized vocabulary is displayed for each group. The ok button 73 is a button for sending, if, for example, a radio button arranged at the top of an association candidate is selected and pressed, selection information, i.e., the association candidate linked to the selected radio button, as a standardized vocabulary.

In the example illustrated in FIG. 23, in the vocabulary candidate field 72, at the top, association candidates, i.e., candidates for standardized vocabularies, such as “name of medicine”, “individual pharmaceutical product code”, “JAN code”, that belong to a pharmaceutical product vocabulary group 74 are displayed. Furthermore, the pharmaceutical product vocabulary group 74 is a vocabulary group that is matched to the other item names. Furthermore, in the vocabulary candidate field 72, if a plurality of vocabulary groups that are matched to the other item names is present, the vocabulary groups are displayed in the order in which the number of matched item names is great. For example, in the vocabulary candidate field 72, a AA vocabulary group 75 in which the number of matched item names is smaller than that in the pharmaceutical product vocabulary group 74 is displayed subsequent to the pharmaceutical product vocabulary group 74. Namely, the submitting unit 140 displays, on the vocabulary candidate field 72, the group that includes the standardized vocabularies that are highly likely to be matched in a processing table.

Furthermore, in the vocabulary candidate field 72, a common vocabulary group 76 is displayed subsequent to the AA vocabulary group 75. Namely, in the vocabulary candidate field 72, the common vocabulary group 76 is displayed as a vocabulary group that is highly likely to be matched subsequent to the vocabulary groups matched to the other item names.

Furthermore, in the vocabulary candidate field 72, a various other vocabulary group 77 are displayed subsequent to the common vocabulary group 76. Furthermore, the various other vocabulary group 77 is displayed for each vocabulary group gathering, for example, a transaction vocabulary group 77a, a products/goods vocabulary group 77b, and the like, that is easily selected.

A description will be given here by referring back to FIG. 1. If the selected standardized vocabulary and the group are input from the submitting unit 140 together with the associated the item name, the association relationship storage control unit 141 associates the item name, the standardized vocabulary, and the group and then stores them in the information DB 121. In this case, because the item name, the standardized vocabulary, and the group are stored in the information DB 121 by the item group determination unit 139, the data may also be stored by being overwritten or, alternatively, a subject record stored in the information DB 121 may also be read and checked with the data.

If the received selection of the standardized vocabulary and the group are input from the submitting unit 140 together with the associated item name, the association relationship storage control unit 141 associates the item name, the standardized vocabulary, and the group and stores them in the information DB 121. Furthermore, the association relationship storage control unit 141 associates the item name, the standardized vocabulary, and the group and stores them in the history DB 123. Namely, from among the association candidates submitted about the item names in each of which a negative determination result has been obtained, the association relationship storage control unit 141 stores the association relationship between the adopted candidate and the item name from which a negative determination result has been obtained in the history DB 123.

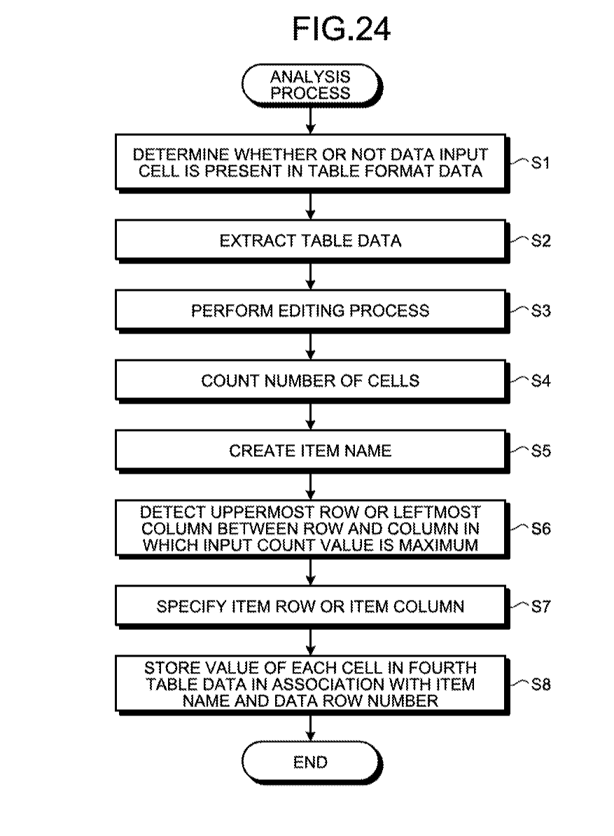

In the following, the operation of the information processing apparatus 100 according to the embodiment will be described. First, an analysis process will be described. FIG. 24 is a flowchart illustrating an example of the analysis process according to the embodiment.

The communication unit 110 in the information processing apparatus 100 receives the table format data from a terminal device (not illustrated). The communication unit 110 outputs the received table format data to the control unit 130. If the table format data is input from the communication unit 110, the determination unit 131 determines whether or not a data input cell is present in the input table format data (Step S1). The determination unit 131 outputs the table format data and the determination result to the extracting unit 132.

If the table format data and the determination result are input from the determination unit 131, the extracting unit 132 extracts, based on the determination result, from the table format data, a chunk of a plurality of consecutive rows or columns in each of which the data input cell is present as a single table data (Step S2). When the extracting unit 132 extracts the table data, the extracting unit 132 outputs the extracted table data as the first table data to the editing unit 133 and the creating unit 135. Furthermore, the extracting unit 132 stores the first table data in the storage unit 120.

When the first table data is input from the extracting unit 132, the editing unit 133 performs the editing process on the input first table data (Step S3). The editing unit 133 outputs the table data in which the editing process has been completed to the count unit 134 and the creating unit 135 as the second table data.

When the second table data is input from the editing unit 133, the count unit 134 counts, for each row or column, the number of cells, in the second table data, in which data has been input (Step S4). The count unit 134 outputs the number of cells counted for each row or column as a count value to the detection unit 136.

The creating unit 135 receives an input of the first table data from the extracting unit 132 and receives an input of the second table data from the editing unit 133. The creating unit 135 temporarily decides, based on the input first table data, an item row or an item column. If the specific cell that has been subjected to the cell concatenation process is included in the temporarily decided item row or the item column, the creating unit 135 temporarily decides the plurality of consecutive item rows or the item columns, which are associated with the specific cells. When the creating unit 135 temporarily decides the plurality of consecutive item rows or the item columns, the creating unit 135 creates an item name of the second table data that has been input from the editing unit 133 (Step S5). The creating unit 135 outputs, as the third table data to the detection unit 136, the second table data in which the created item name is used. If the specific cell that has been subjected to the cell concatenation process is not included in the temporarily decided item row or the item column, the creating unit 135 outputs the input second table data as the third table data to the detection unit 136 without processing anything.

The detection unit 136 receives an input of a count value from the count unit 134 and receives an input of the third table data from the creating unit 135. The detection unit 136 detects the uppermost row or the leftmost column between the row and the column in which the input count value is the maximum in the input third table data (Step S6). The detection unit 136 outputs the detected uppermost row or the detected leftmost column as a detection result to the specifying unit 137 together with the count value and the third table data.

The specifying unit 137 receives an input of the detection result, the count value, and the third table data from the detection unit 136. The specifying unit 137 specifies an item row or an item column based on the detection result, the count value, and the third table data (Step S7). The specifying unit 137 sets the specified third table data to the fourth table data and outputs the specified item row or the item column and the fourth table data to the storage control unit 138.

The storage control unit 138 receives an input of the specified item row or the item column and the fourth table data from the specifying unit 137. The storage control unit 138 associates, based on the specified item row or the item column and based on the fourth table data, the value of each of the cells in the fourth table data with the item name and the data row number and stores the associated information in the information DB 121 (Step S8). When the storage control unit 138 stores, in an associated manner, the data row number, the item name, and the value in the information DB 121, the storage control unit 138 outputs the determination instruction to the item group determination unit 139. Consequently, the information processing apparatus 100 can easily register table format data with various formats in databases.

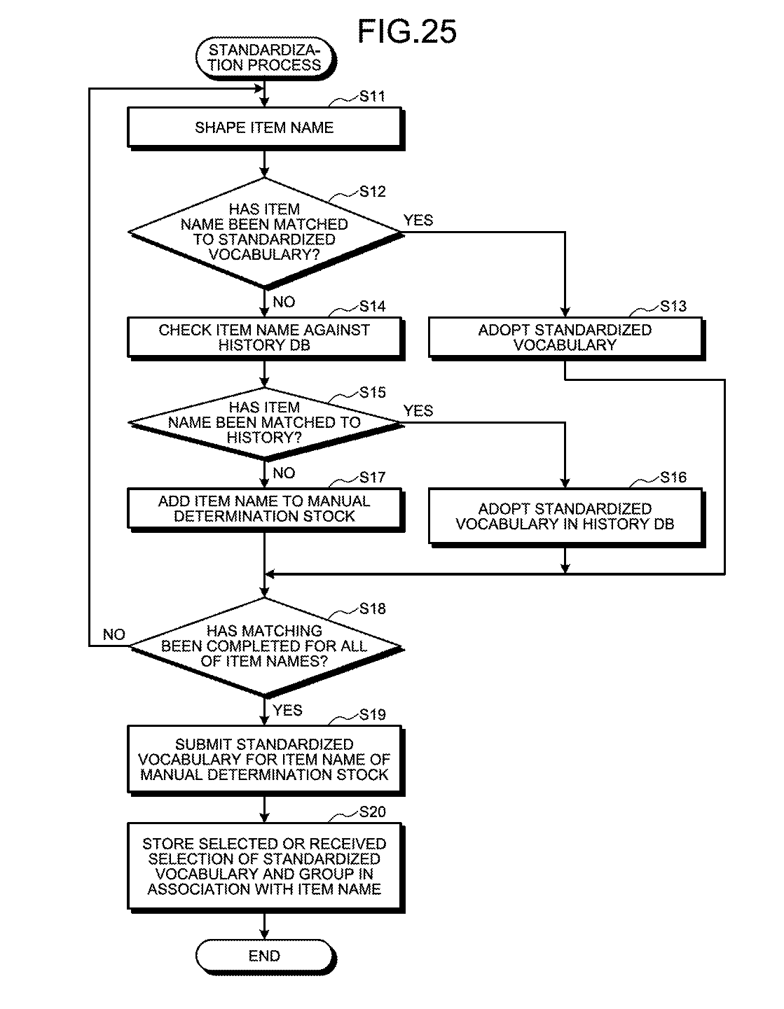

In the following, a standardization process will be described. FIG. 25 is a flowchart illustrating an example of the standardization process according to the embodiment.

When the determination instruction is input from the storage control unit 138, the item group determination unit 139 sequentially reads item names from the first record in the information DB 121. The item group determination unit 139 shapes the read item names (Step S11). The item group determination unit 139 refers to the vocabulary DB 122 and performs a matching process on the standardized vocabulary by using the shaped item names. The item group determination unit 139 determines whether the item name is matched to the standardized vocabulary (Step S12).

If the item name is matched to the standardized vocabulary (Yes at Step S12), the item group determination unit 139 adopts the matched standardized vocabulary (Step S13) and proceeds to Step S18. The item group determination unit 139 stores the adopted standardized vocabulary and the group to which the standardized vocabulary belongs in the information DB 121.

If the item name is not matched to the standardized vocabulary (No at Step S12), the item group determination unit 139 checks the item name in the history DB 123 (Step S14). Namely, the item group determination unit 139 performs the matching process on the item name and the past association history obtained from the manual determination. The item group determination unit 139 determines whether the item name is matched to the item name in the history DB 123 (Step S15).

If the item name is matched to the item name in the history DB 123 (Yes at Step S15), the item group determination unit 139 adopts the standardized vocabulary in the history DB 123 (Step S16) and proceeds to Step S18. The item group determination unit 139 stores the adopted standardized vocabulary and the group to which the standardized vocabulary belongs in the information DB 121. If the item name is not matched to the item name in the history DB 123 (No at Step S15), the item group determination unit 139 adds the item name to the manual determination stock (Step S17).

The item group determination unit 139 determines whether matching has been completed for all of the item names (Step S18). If matching has not been completed for all of the item names (No at Step S18), the item group determination unit 139 returns to Step S11. If matching has been completed for all of the item names (Yes at Step S18), the item group determination unit 139 outputs the submission instruction to the submitting unit 140.

If the submission instruction is input from the item group determination unit 139, the submitting unit 140 selects, regarding item name associated with standardized vocabulary and the group stored in the information DB 121, the stored standardized vocabulary as the association target. The submitting unit 140 outputs the selected standardized vocabulary and the group together with the associated item name to the association relationship storage control unit 141.

The submitting unit 140 sends, regarding the item name stored in the manual determination stock, an allocation screen that is used to submit a standardized vocabulary candidate to a terminal device (not illustrated) and allow the terminal device to display the allocation screen (Step S19). The submitting unit 140 receives selection information from the terminal device (not illustrated). The submitting unit 140 receives the selection information and outputs the received selection of the standardized vocabulary and the group together with the associated item name to the association relationship storage control unit 141.

The association relationship storage control unit 141 receives an input of the selected standardized vocabulary and the group and the associated item name from the submitting unit 140. Alternatively, the association relationship storage control unit 141 receives an input of the received selection of the standardized vocabulary and the group and receives an input of the associated item name from the submitting unit 140. The association relationship storage control unit 141 associates the selected or the received selection of standardized vocabulary and the group with the item name and then stores them in the information DB 121 (Step S20). Furthermore, the association relationship storage control unit 141 associates the received selection of standardized vocabulary and the group with the item name and stores them in the history DB 123. Consequently, the information processing apparatus 100 can associate an item name with the standardized vocabulary. Furthermore, by using the standardized vocabulary, the information processing apparatus 100 can integrate and use various kinds of data. Furthermore, the information processing apparatus 100 can submit an appropriate standardized vocabulary with respect to an item name in which the standardized vocabulary is not automatically adopted.

In this way, the information processing apparatus 100 extracts a plurality of item names from the table format data. Furthermore, the information processing apparatus 100 refers to the vocabulary DB 122 that stores therein a plurality of item groups and determines which item group includes an item name that has a predetermined similar relationship with each of the plurality of extracted item names. Furthermore, the information processing apparatus 100 selects, as an association target from among the plurality of item names, regarding the item name from which a positive determination result has been obtained, the item name that has the predetermined similar relationship. Furthermore, the information processing apparatus 100 selects, as an association candidate, regarding the item name from which a negative determination result has been obtained, the item group that is determined to include the item name having the predetermined similar relationship with another item name. Consequently, the item name can be associated with the standardized vocabulary.

Furthermore, regarding the item name from which a negative determination result has been obtained, when the information processing apparatus 100 submits the item group that is determined to include the item name having the predetermined similar relationship with another item name as an association candidate, the information processing apparatus 100 further submits a predetermined item group as another association candidate. Consequently, the information processing apparatus 100 can submit the standardized vocabulary in a group that is highly likely to be matched.

Furthermore, in the information processing apparatus 100, a plurality of item groups includes an item group that is formed for each type of industry and an item group that is formed common to a type of industry and the predetermined item group is associated with the item group that is formed common to the type of industry.

Consequently, the information processing apparatus 100 can submit the standardized vocabulary in a group that is highly likely to be matched.

Furthermore, in the information processing apparatus 100, the plurality of item names is extracted from a table that is detected as a single table from table format data. Consequently, the information processing apparatus 100 can associate an item name in the table with the standardized vocabulary.

Furthermore, in the information processing apparatus 100, the plurality of item names has been extracted from a plurality of tables that are detected from the table format data. Furthermore, regarding the item name in which the negative determination result has been obtained, the information processing apparatus 100 submits, as an association candidate, the item group that is determined to include the item name having the predetermined similar relationship with the other item name extracted from the same table from among the plurality of tables. Consequently, the information processing apparatus 100 can submit the standardized vocabulary in the group that is highly likely to be matched.

Furthermore, if it is determined that the first item name having the predetermined similar relationship with an item name that is included in the same table that includes the item name from which the negative determination result has been obtained is included and if it is determined that the item name having the predetermined similar relationship with the second item name that is included in the table different from the table that includes the item name from which the negative determination result has been obtained is included, regarding the item name from which the negative determination result has been obtained, the information processing apparatus 100 submits the item group that includes the first item name as an association candidate with priority over the item group that includes the second item name. Consequently, the information processing apparatus 100 can submit the standardized vocabulary in the group in which the other matched item name is included.

Furthermore, from among the association candidates submitted for the item name from which the negative determination result has been obtained, the information processing apparatus 100 stores, in the history DB 123, an association relationship between an adopted candidate and the item name from which the negative determination result has been obtained. Furthermore, if the item name extracted from the table format data or another table format data is associated with a specific item name by the association relationship, the information processing apparatus 100 selects the specific item name as an association target of the item name extracted from the table format data or the other table format data. Consequently, the information processing apparatus 100 can submit the standardized vocabulary in the group included in the history.

Furthermore, when submitting an association candidate for the other item name from which the negative determination result has been obtained, the information processing apparatus 100 submits the item group that includes the specific item name as the association candidate with priority over the other item group. Consequently, the information processing apparatus 100 can submit the standardized vocabulary in the group included in the history with priority.

Furthermore, the information processing apparatus 100 stores, in the information DB 121, the item name selected as the association target or the item name that has been received selection from among the item names included in the submitted item group in association with each of the plurality of item names in the table format data. Consequently, the information processing apparatus 100 can associate the item names with the standardized vocabularies.

Furthermore, the information processing apparatus 100 determines whether or not a data input cell is present regarding each row or column in the input table format data. Furthermore, the information processing apparatus 100 extracts a chunk of a plurality of consecutive rows or columns in each of which the data input cell is present to a single table as a correlated portion. Furthermore, the information processing apparatus 100 specifies an item row or an item column in the chunk of rows or columns. Furthermore, the information processing apparatus 100 extracts, as the item name, the data input in each of the cells in the specified item row or the item column. Consequently, the information processing apparatus 100 can extract the item name from the table format data.

In the embodiment described above, a case in which the title of the table is represented in an upper portion of the body portion of the table has been described; however, the embodiment is not limited to this. For example, even if a header or a comment is represented in a few rows in the upper portion of the body portion of the table, similarly to the embodiment described above, the information processing apparatus 100 can extract the body portion of the table.

Furthermore, in the embodiment described above, as the form of the information DB 121, a single record is stored in each of the cells that constitute the table data; however, the embodiment is not limited to this. For example, any type of databases may also be used for the information DB 121 as long as the original table data can be restored.

Furthermore, in the embodiment described above, a standardized vocabulary and a group are also decided at the same time when the table data is registered in the information DB 121; however, the embodiment is not limited to this. For example, the standardization process for deciding a standardized vocabulary and a group may also be performed when the table data stored in the information DB 121 is used. Consequently, it is possible for a user who uses the table data to decide the standardized vocabulary and the group based on a unified standard. Furthermore, for example, when various kinds of data on another municipality are registered, another municipality or a vendor can support the registration.

Furthermore, the components of each unit illustrated in the drawings are not always physically configured as illustrated in the drawings. In other words, the specific shape of a separate or integrated device is not limited to the drawings. Specifically, all or part of the device can be configured by functionally or physically separating or integrating any of the units depending on various loads or use conditions. For example, the determination unit 131 and the extracting unit 132 may also be integrated. Furthermore, each of the process illustrated in the drawings is not limited to the order described above and may also be simultaneously performed or may also be performed by changing the order of the processes as long as the processes do not conflict with each other.

Furthermore, all or any part of various processing functions performed by each unit may also be executed by a CPU (or a microcomputer, such as an MPU, a micro controller unit (MCU), or the like). Furthermore, all or any part of various processing functions may also be, of course, executed by programs analyzed and executed by the CPU (or the microcomputer, such as the MPU or the MCU), or executed by hardware by wired logic.

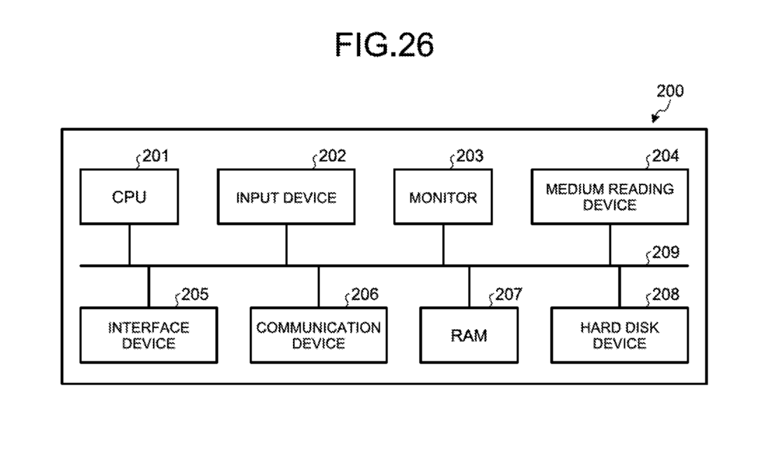

The various processes described in the above embodiment can be implemented by programs prepared in advance and executed by a computer. Accordingly, in the following, an example of a computer that executes programs having the same function as that described in the embodiments described above will be described. FIG. 26 is a diagram illustrating an example of a computer that executes item name association processing program.

As illustrated in FIG. 26, a computer 200 includes a CPU 201 that executes various kinds arithmetic processing, an input device 202 that receives an input of data, and a monitor 203. Furthermore, the computer 200 includes a medium reading device 204 that reads programs or the like from a storage medium, an interface device 205 that is used to connect various devices, and a communication device 206 that is used to connect to the other information processing apparatuses in a wired or wireless manner. Furthermore, the computer 200 includes a RAM 207 that temporarily stores therein various kinds of information and a hard disk device 208. Furthermore, each of the devices 201 to 208 is connected to a bus 209.

The hard disk device 208 stores therein an item name association processing program having the same function as that performed by each of the processing units, such as the determination unit 131, the extracting unit 132, the editing unit 133, the count unit 134, the creating unit 135, the detection unit 136, the specifying unit 137, and the storage control unit 138 illustrated in FIG. 1. Furthermore, the hard disk device 208 stores therein the item name association processing program having the same function as that performed by each of the processing units, such as the item group determination unit 139, the submitting unit 140, and the association relationship storage control unit 141. Furthermore, the hard disk device 208 stores therein the information DB 121, the vocabulary DB 122, the history DB 123, and various kinds of data that implements the item name association processing program. The input device 202 receives an input of various kinds of information, such as operation information, management information, from, for example, an administrator of the computer 200. The monitor 203 displays, for example, various screens, such as a management screen, with respect to the administrator of the computer 200. For example, a printer device or the like is connected to the interface device 205. The communication device 206 has the same function as that performed by, for example, the communication unit 110 illustrated in FIG. 1, is connected to a network (not illustrated), and sends and receives various kinds of information to and from a terminal device (not illustrated).

The CPU 201 reads each of the programs stored in the hard disk device 208 and loads and executes the programs in the RAM 207, thereby executing various kinds of processing. Furthermore, these programs can allow the computer 200 to function as the determination unit 131, the extracting unit 132, the editing unit 133, the count unit 134, the creating unit 135, the detection unit 136, the specifying unit 137, and the storage control unit 138 illustrated in FIG. 1. Furthermore, these programs can allow the computer 200 to function as the item group determination unit 139, the submitting unit 140, and the association relationship storage control unit 141 illustrated in FIG. 1.

Furthermore, the item name association processing program described above does not always need to be stored in the hard disk device 208. For example, the computer 200 may also read and execute the program stored in a storage medium that can be read by the computer 200. Examples of the computer 200 readable storage medium include a portable recording medium, such as a CD-ROM, a DVD disk, a universal serial bus (USB) memory, or the like, a semiconductor memory, such as a flash memory or the like, and a hard disk drive. Furthermore, the item name association processing program may also be stored in a device connected to a public circuit, the Internet, a LAN, or the like and the computer 200 may also read and execute the item name association processing program from the recording medium described above.

It is possible to associate an item name with a standardized vocabulary.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An item name association processing method comprising:
extracting a plurality of item names from table format data, using a processor;
referring to a storage in which a plurality of item groups is stored and determining which item group includes an item name that has a predetermined similar relationship with the plurality of individual extracted item names, using the processor; and
selecting, as an association target, from among the plurality of item names, regarding the item name from which a positive determination result has been obtained, the item name having the predetermined similar relationship and submitting, as an association candidate, from among the plurality of item names, regarding the item name from which a negative determination result has been obtained, the item group determined to include the item name having the predetermined similar relationship with another item name, using the processor.

2. The item name association processing method according to claim 1, wherein, regarding the item name from which the negative determination result has been obtained, the submitting includes further submitting, when submitting the item group determined to include the item name having the predetermined similar relationship with the other item name as the association candidate, a predetermined item group as another association candidate.

3. The item name association processing method according to claim 2, wherein the plurality of item groups includes an item group that is formed for each type of industry and an item group that is formed common to the type of industry and the predetermined item group is associated with the item group that is formed common to the type of industry.

4. The item name association processing method according to claim 1, wherein the plurality of item names is extracted from a table that is detected as a single table from the table format data.

5. The item name association processing method according to claim 1, wherein
the plurality of item names has been extracted from a plurality of tables that was detected from the table format data, and
regarding the item name from which the negative determination result has been obtained, the submitting includes submitting, as an association candidate, the item group determined to include the item name having the predetermined similar relationship with the other item name extracted from the same table from among the plurality of tables.

6. The item name association processing method according to claim 1, when it is determined that a first item name having the predetermined similar relationship with an item name that is included in the same table that includes the item name from which the negative determination result has been obtained is included and when it is determined that the item name having the predetermined similar relationship with a second item name that is included in a table different from the table that includes the item name from which the negative determination result has been obtained is included, the submitting includes submitting, regarding the item name from which the negative determination result has been obtained, the item group that includes the first item name as an association candidate with priority over the item group that includes the second item name.

7. The item name association processing method according to claim 1, further comprising
storing in the storage, from among the association candidates submitted for the item name from which the negative determination result has been obtained, an association relationship between an adopted candidate and the item name from which the negative determination result has been obtained, using the processor, wherein
when an item name extracted from the table format data or another table format data is associated with a specific item name by the association relationship, the submitting includes selecting the specific item name as an association target for the item name extracted from the table format data or the other table format data.

8. The item name association processing method according to claim 7, wherein, when submitting an association candidate for the other item name from which the negative determination result has been obtained, the submitting includes submitting the item group that includes the specific item name as an association candidate with priority over the other item group.

9. The item name association processing method according to claim 1, wherein
the item name selected as the association target or the item name that has been received selection from among the item names included in the submitted item group is associated with the plurality of individual item names in the table format data and is stored in the storage.

10. The item name association processing method according to claim 1, wherein
the extracting the item name includes
determining whether or not a data input cell is present regarding each row or column in the input table format data, using the processor,
extracting a chunk of a plurality of consecutive rows or columns in each of which the data input cells are present to a single table as a correlated portion, using the processor,
specifying an item row or an item column in the chunk of rows or columns, using the processor, and
extracting, as the item name, data that is input in each of the cells in the specified item row or the item column, using the processor.

11. A non-transitory computer-readable recording medium having stored therein an item name association processing program that causes a computer to execute a process comprising:
extracting a plurality of item names from table format data;
referring to a storage in which a plurality of item groups is stored and determining which item group includes an item name that has a predetermined similar relationship with the plurality of individual extracted item names; and
selecting, as an association target, from among the plurality of item names, regarding the item name from which a positive determination result has been obtained, the item name having the predetermined similar relationship and submitting, as an association candidate, from among the plurality of item names, regarding the item name from which a negative determination result has been obtained, the item group determined to include the item name having the predetermined similar relationship with another item name.

12. The non-transitory computer-readable recording medium according to claim 11, wherein, regarding the item name from which the negative determination result has been obtained, the submitting includes further submitting, when submitting the item group determined to include the item name having the predetermined similar relationship with the other item name as the association candidate, a predetermined item group as another association candidate.

13. The non-transitory computer-readable recording medium according to claim 11, wherein
the plurality of item names has been extracted from a plurality of tables that was detected from the table format data, and
regarding the item name from which the negative determination result has been obtained, the submitting includes submitting, as an association candidate, the item group determined to include the item name having the predetermined similar relationship with the other item name extracted from the same table from among the plurality of tables.

14. The non-transitory computer-readable recording medium according to claim 11, when it is determined that a first item name having the predetermined similar relationship with an item name that is included in the same table that includes the item name from which the negative determination result has been obtained is included and when it is determined that the item name having the predetermined similar relationship with a second item name that is included in a table different from the table that includes the item name from which the negative determination result has been obtained is included, the submitting includes submitting, regarding the item name from which the negative determination result has been obtained, the item group that includes the first item name as an association candidate with priority over the item group that includes the second item name.

15. The non-transitory computer-readable recording medium according to claim 11, wherein
the extracting the item name includes
determining whether or not a data input cell is present regarding each row or column in the input table format data,
extracting a chunk of a plurality of consecutive rows or columns in each of which the data input cells are present to a single table as a correlated portion,
specifying an item row or an item column in the chunk of rows or columns, and
extracting, as the item name, data that is input in each of the cells in the specified item row or the item column.

16. An information processing apparatus comprising:
a memory; and
a processor coupled to the memory, wherein the processor executes a process comprising:
extracting a plurality of item names from table format data;
referring to a storage in which a plurality of item groups is stored and determining which item group includes an item name that has a predetermined similar relationship with the plurality of individual extracted item names; and
selecting, as an association target, from among the plurality of item names, regarding the item name from which a positive determination result has been obtained, the item name having the predetermined similar relationship and submitting, as an association candidate, from among the plurality of item names, regarding the item name from which a negative determination result has been obtained, the item group determined to include the item name having the predetermined similar relationship with another item name.

17. The information processing apparatus according to claim 16, wherein, regarding the item name from which the negative determination result has been obtained, the submitting includes further submitting, when submitting the item group determined to include the item name having the predetermined similar relationship with the other item name as the association candidate, a predetermined item group as another association candidate.

18. The information processing apparatus according to claim 16, wherein
the plurality of item names has been extracted from a plurality of tables that was detected from the table format data, and
regarding the item name from which the negative determination result has been obtained, the submitting includes submitting, as an association candidate, the item group determined to include the item name having the predetermined similar relationship with the other item name extracted from the same table from among the plurality of tables.

19. The information processing apparatus according to claim 16, when it is determined that a first item name having the predetermined similar relationship with an item name that is included in the same table that includes the item name from which the negative determination result has been obtained is included and when it is determined that the item name having the predetermined similar relationship with a second item name that is included in a table different from the table that includes the item name from which the negative determination result has been obtained is included, the submitting includes submitting, regarding the item name from which the negative determination result has been obtained, the item group that includes the first item name as an association candidate with priority over the item group that includes the second item name.

20. The information processing apparatus according to claim 16, wherein
the extracting the item name includes
determining whether or not a data input cell is present regarding each row or column in the input table format data,
extracting a chunk of a plurality of consecutive rows or columns in each of which the data input cells are present to a single table as a correlated portion, and
specifying an item row or an item column in the chunk of rows or columns, and
extracting, as the item name, data that is input in each of the cells in the specified item row or the item column.
